(19) United States
(12) Patent Application Publication
(10) Pub. No.: US 2008/0144985 A1
(43) Pub. Date: Jun. 19, 2008

(54) Wheel End With Monitoring Capabilities

(75) Inventors: Mark A. Joki, Dover, OH (US); Mircea Gradu, Massillon, OH (US); Scott A. Warren, Dover, OH (US); Steven A. Roman, North Canton, OH (US); John D. Dougherty, Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, Canton, OH (US)

(21) Appl. No.: 11/853,152

(22) Filed: Sep. 11, 2007

Related U.S. Application Data
(60) Provisional application No. 60/870,266, filed on Dec. 15, 2006.
(60) Provisional application No. 60/895,157, filed on Mar. 16, 2007.
(60) Provisional application No. 60/912,085, filed on Apr. 16, 2007.

(51) Int. Cl. F16C 19/52; B60B 27/00; G01L 5/12

(52) U.S. Cl. 384/448; 301/109; 73/862

(57) ABSTRACT

An automotive vehicle has road wheels that are coupled to suspension uprights of the vehicle through wheel ends that have the capacity to monitor lateral loads that act on the road wheels at tire patches where the road wheels contact a road surface. Each wheel end offsets displacements that would be produced within the wheel end by vertical loads with displacements that would be produced by moments induced by the vertical loads, so that the remaining displacements within the wheel end reflect essentially lateral loads exerted at the tire patch. The wheel end contains a sensor and a target that the sensor monitors to detect the presence and magnitude of the displacements and hence the magnitude and direction of the lateral force at the tire patch. The sensor may also monitor angular velocity, angular position, and temperature.

### CROSS-REFERENCE TO RELATED APPLICATIONS

This application derives and claims priority from U.S. Provisional Application Ser. No. 60/870,266 filed Dec. 15, 2006, from U.S. Provisional Application Ser. No. 60/895,157 filed Mar. 16, 2007, and from U.S. Provisional Application Ser. No. 60/912,085 filed Apr. 16, 2007, each of which is incorporated herein by reference.

### STATEMENT REGARDING FEDERALLY SPONSORED RESEARCH

Not Applicable.

### BACKGROUND OF THE INVENTION

This invention relates to bearing assemblies and more particularly to a wheel end having the capacity to produce signals that represent loads acting on and other conditions at the road wheels mounted on such wheel ends and to a process for monitoring such loads.

In many automotive vehicles of current manufacture the road wheels for those vehicles are coupled to the suspension systems of the vehicles through bearing assemblies called wheel ends, and this holds true irrespective of whether the wheels are driven or non-driven. The typical wheel end includes a housing, a hub that rotates in and beyond the housing, and an antifriction bearing located between the hub and the housing. The housing is attached to a suspension upright on the vehicle, whereas a road wheel is secured to the hub. The bearing must have the capacity to transfer radial loads between the housing and the hub, and also axial (thrust) loads in both axial directions. To this end, the bearing usually has rolling elements arranged in two rows, with the rolling elements of the one row operating along raceways inclined in one direction and the rolling elements of the other row operating along raceways inclined in the opposite direction. Typically, outside manufactures supply the wheel ends as packaged assemblies with the bearings preset and pre-lubricated.

Some wheel ends have speed sensors attached to their housings and target wheels carried by their hubs. The speed sensors monitor the rotation of the target wheels—and hence the road wheels—and thus provide signals reflecting angular velocity. Antilock braking systems and traction control systems utilize such signals.

To maintain even more control over vehicle performance, some vehicles have dynamic or stability control systems to maintain vehicle stability. These systems may manage drive train power, braking, steering and even suspension system components, and hence enhance safety. That type of system will work best if it relies on loads at the so-called tire patches for a vehicle, that is, where the tires of the road wheels contact the road surface, and these loads are essentially loads transmitted through the wheel ends for the vehicle. Maneuvering through a turn will create thrust loads at the wheel ends and laterally directed forces at the tire patches, and these represent the most critical aspects of dynamic control.

### BRIEF DESCRIPTION OF THE SEVERAL VIEWS OF THE DRAWINGS

FIG. 1 is a sectional view of a wheel end and constructed in accordance with and embodying the present invention, with the wheel end being secured to a suspension upright and having a road wheel mounted on it;

FIG. 2 is an enlarged sectional view of the wheel end of the present invention;

FIG. 3 is a schematic view of an automotive vehicle provided with wheel ends of the present invention and also a stability control system;

FIG. 4 is a sectional view of a modified wheel end of the present invention;

FIG. 5 is a enlarged sectional view of the sensor and target wheel of the modified wheel end; and

FIG. 6 is a graphical illustration of displacements in a wheel end in response to lateral and vertical loads.

### DETAILED DESCRIPTION

Before any embodiments of the invention are explained in detail, it is to be understood that the invention is not limited in its application to the details of construction and the arrangement of components set forth in the following description or illustrated in the drawings.

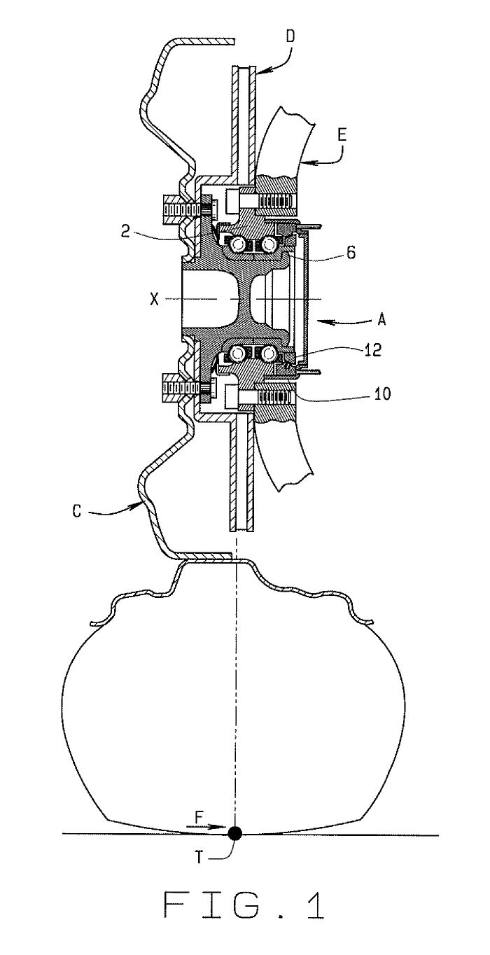

Referring now to the drawings, a bearing assembly in the form of a wheel end A (FIG. 1) serves to attach a road wheel C and a brake disk D or drum to a suspension upright E of an automotive vehicle. It enables the wheel C to rotate about an axis X and further has the capacity to detect forces, primarily lateral forces, that act on the road wheel C at the “tire patch” T—actually the center of where the tire for the road wheel C contacts the road surface. Lateral forces are greatest when the vehicle negotiates a turn. The signals may be directed from the wheel end A to a processor forming part of a stability control system for the vehicle having the wheel end A. At the front of the vehicle, the suspension upright E takes the form of a steering knuckle and thus not only displaces vertically with respect to the vehicle chassis, but also pivots. When at the rear of the vehicle, the suspension upright E simply moves upwardly and downwardly relative to the vehicle chassis. Both are, of course, part of the suspension system for the vehicle. At either location the wheel C that is coupled to the suspension upright E by the wheel end A may be driven or not driven through that wheel end A or not driven.

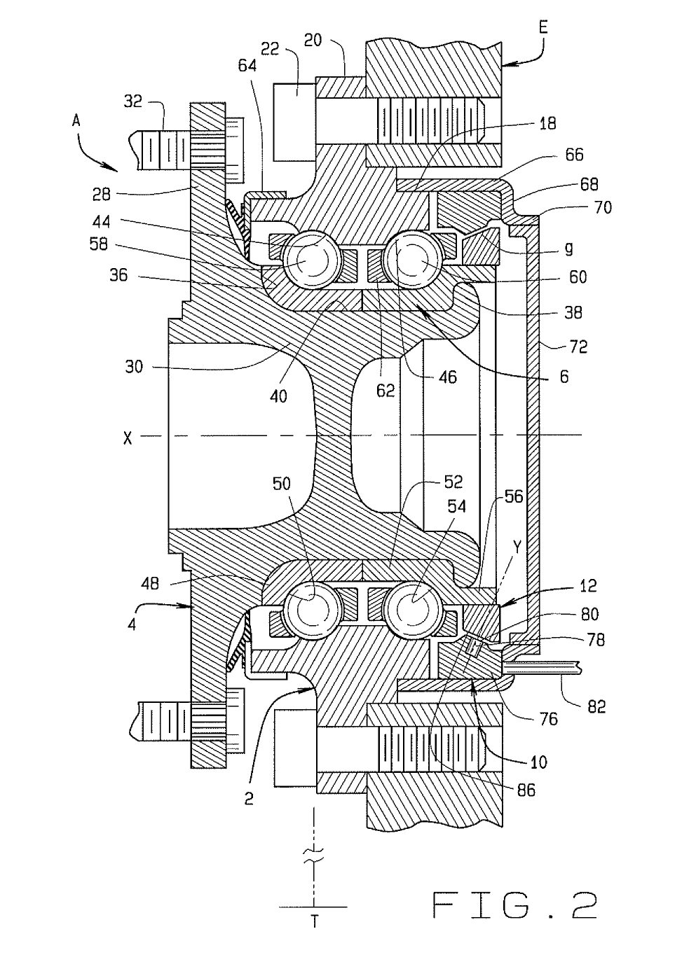

Basically, the wheel end A includes (FIG. 2) a housing 2 that is secured firmly to the suspension upright E, a hub 4 on which the road wheel C is mounted, and an antifriction bearing 6 located between the housing 2 and the hub 4 to enable the hub 4 to rotate in the housing 2 about the axis X. In addition the wheel end A includes a sensor 10 supported on the housing 2 and a target wheel 12 carried by the hub 4 at the bearing 6. The sensor 10 monitors the space between it and the target wheel 12, and the changes in that space so monitored reflect forces at the tire patch T that are transferred through the wheel end A. It is particularly sensitive to lateral loads at the tire patch T and less sensitive to vertical loads and other radial loads. It may also monitor the angular velocity of the hub 4, which is the angular velocity of the wheel C.

The housing 2 functions as the non-rotating component of the wheel end A. It has a generally tubular configuration to accommodate the bearing 6. At its outboard end the housing 2 projects slightly beyond the bearing 6. At its inboard end it provides a cylindrical mounting surface 18. Intermediate its ends the housing 2 has a mounting flange 20. Here the housing 2—and the entire wheel end A—is secured to the suspension upright E with cap screws 22 or other suitable means.

The hub 4 represents the rotating component of the wheel end A. It includes a wheel flange 28 that lies beyond the outboard end of the housing 2 and a spindle 30 that extends from the wheel flange 28 into the housing 2. The wheel flange 28 is fitted with lug bolts 32 over which nuts 34 thread. The bolts 32 and nuts 34 secure the brake disk D and road wheel C against the wheel flange 28, so that the hub 4 rotates with the road wheel C and brake disk D. The spindle 30 emerges from the wheel flange 28 at a shoulder 36 and leads out to a formed end 38. Between the shoulder 36 and the formed end 38 the spindle 30 has a cylindrical bearing seat 40.

The bearing 6 includes outboard and inboard outer raceways 44 and 46, respectively, that are surfaces of arcuate cross section on the housing 2 itself, although one or both may be formed on separate races that are pressed into the housing 2. Both raceways 44 and 46 are presented generally inwardly toward the spindle 30 of the hub 4 and are inclined downwardly toward each other. The bearing 6 also includes an outboard inner race 48 that fits over the cylindrical bearing seat 40 of the spindle 30 with an interference fit and against the shoulder 36 at the end of the seat 40. It has a raceway 50 of arcuate cross section that is presented outwardly toward the outboard outer raceway 44 on the housing 2, and although being inclined in the same direction as the raceway 44, it is displaced farther toward the outboard end of the wheel end A. The outboard inner race 48 may be formed integral with the spindle 30. In addition, the bearing 6 has an inboard inner race 52 that fits over the bearing seat 40 with an interference fit and against the formed end 38 at the end of the spindle 30. It has a raceway 54 that is presented outwardly toward the inboard outer raceway 46, and although being inclined in the same direction as the raceway 46, it is displaced axially farther toward the inboard end of the wheel end A. The inboard race 52 also has an axial extension 56 that projects over and beyond the formed end 38 on the spindle 30. Thus, the two inner races 48 and 52 encircle the spindle 30 where they are captured between the shoulder 36 and the formed end 38.

Completing the bearing 6 are rolling elements in the form of an outboard row of balls 58 and an inboard row of balls 60, each confined by a cage 62. The balls 58 of the outboard row contact the outboard raceways 44 and 50, and owing to the inclination of the raceways 44 and 50, transfer thrust loads in one axial direction, whereas the balls 60 of the inboard row contact the inboard raceways 46 and 52 and transfer thrust loads in the opposite axial direction. The balls 58 and 60 of both rows transfer radial loads. Preferably, the bearing 6 is assembled such that it possesses a slight preload. As such, no radial or axial clearances exist within it. The center of the bearing 6 lies midway between the two rows of balls 58 and 60, and that center is normally offset axially from the tire patch T toward the outboard end of the wheel end A, although those of ordinary skill in the art will recognize that the center is not required to be axially offset from the tire patch T.

Other types of antifriction bearings may be substituted for the ball bearing 6—for example, a tapered roller bearing or a spherical roller bearing or even a cylindrical roller bearing.

Initially, the spindle 30 does not have the formed end 38. Instead, the portion of the spindle 30 that eventually provides the formed end 38 exists as an axially directed extension of the spindle 30 with a diameter no greater than that of the bearing seat 40. Only after the outboard inner race 48 along with its row of balls 58 is pressed over the bearing seat 40, the housing 2 is installed over them, and then the inboard inner race with its row of balls 60 is pressed over the bearing seat 40, in that order, is the axially directed extension upset, preferably by roll forming, into the formed end 38. Other arrangements for capturing the bearing 6 on the spindle 30 may be substituted for the formed end 38—for example, a nut threaded over the end of the spindle 30 or a snap ring engaged with the end of the spindle 30.

At the outboard end of the housing 2 a seal 64 fits over that end and wipes the back surface of the wheel flange 28 on the hub 4, so as to provide a dynamic fluid barrier between the housing 2 and hub 4.

The sensor 10 fits within a sensor case 66 that in turn fits over the mounting surface 18 on the housing 2. The sensor case 66 extends axially beyond the housing 2 and around the axial extension 56 of the inboard inner race 52, then turns inwardly in the provision of a short radial wall 68, and then axially again in the provision of a retaining lip 70 that receives a removable end cap 72. Directly below the axis X, the sensor case 66 holds the sensor 10 which includes a polymer ring 76 molded against the interior surface of the case 66 toward and along the radial wall 68. Apart from the ring 76, the sensor 10 includes a sensing element 78 that is embedded in the ring 76 and has a sensing face 80 that is presented inwardly toward the axis X. Actually, the sensing element 78 is aligned with an axis Y that lies in a vertical or near vertical plane and is slightly oblique to the axis X, yet intersects the axis X. Hence, the sensing face 80, which is perpendicular to the axis Y, also lies oblique to the axis X. The included angle between the sensing face 80 and the axis X should range between 10° and 35° and preferably should be about 15°. Finally, the sensor 10 has a lead 82 that extends from the sensing element 78, through the polymer ring 76, and emerges from the case 66 through its radial wall 68.

The target wheel 12 fits with an interference fit over the axial extension 56 on the inboard inner race 52. It has a reference surface 86 that is presented outwardly toward the sensor 10 and is oriented at the same angle as the sensing face 80. The reference surface 86 lies within a conical envelope—or close to a conical envelope—having its apex along the axis X outboard from the sensor 10. Yet, the reference surface 86 is spaced slightly from the sensing face 80, so that a gap g exists between the sensing face 80 and the reference surface 86 when the target wheel 12 rotates within the sensor 10. The target wheel 12 may also incorporate discontinuities, such as gear teeth in a powdered metal or stamped target wheel or alternating magnetic poles in a magnetic encoder ring, to which a speed sensor will respond so as to produce a signal that reflects the angular velocity of the target wheel 12 and hub 4. Those of ordinary skill in the art will recognize that the construction of the target wheel 12 may be varied from that describe herein, so as to match the type of speed sensor to be used, and accordingly, is not intended to be limited to the specific examples shown and described.

But just as significantly the sensor 10 measures and monitors the size of the gap g. To this end, the sensing element 78 may use a static magnetic field excitation where the size of the gap g influences the rate and amount of flux change due to surface discontinuities, as well as the magnitude of the flux density. The sensing element 78 may sense the flux change by the Hall effect, magneto resistive effect, or coil-based methods. The sensing element 78 may use an AC magnetic field excitation where impedance changes, caused by distance to the reference surface of the target wheel 12, are sensed, such as with eddy current sensors. Preferably, the sensing element 78 has the capacity to detect changes in the air gap g which are as small as 0.5 microns.

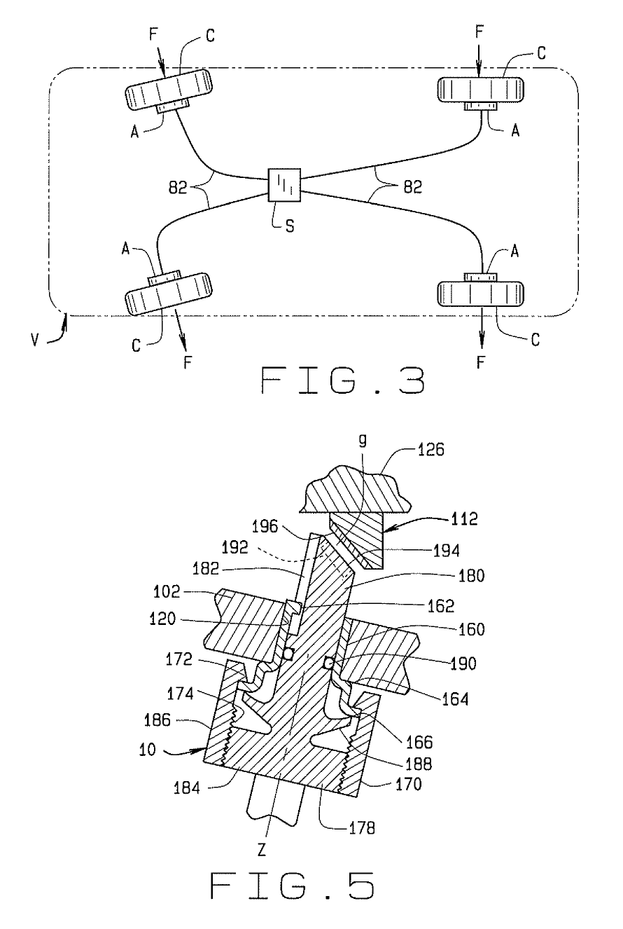

Basically, the sensor 10 can provide information to a central control unit S (FIG. 3) on a vehicle V. The sensor 10 may be a Hall-type sensor which provides a voltage or current output corresponding to the instantaneous magnetic field strength and therefore the size of the gap g between the target wheel 12 and sensing element 78. The sensor output may consist of a pulse train whose duty cycle corresponds to the magnetic field strength. The sensor output may also be a serial data stream containing information solely about the instantaneous magnetic field strength. The sensor output may contain separate information corresponding to rotational angle, speed, temperature, and/or displacement.

Not only does the sensing element 78 of the sensor 10 monitor the size of the gap g as the hub 4 rotates, it also serves to initially position the target wheel 12 on the axial extension 56 of the inboard inner race 52. In this regard, the sensor 10 functions best, when the initial gap g, that is to say the gap g at assembly, is set for a precise distance. To achieve this initial size, the target wheel 12 is pressed over the axial extension 56 until the sensor 10 registers a signal reflecting that the gap g is the proper initial size.

In the operation of the vehicle V having its road wheel C fitted to the suspension uprights E of that vehicle with the wheel ends A, each wheel end A will transfer some of the weight of the vehicle to its road wheel C and thence to the underlying road surface at the tire patch T where the wheel C contacts the road surface. The wheel end A transfers a vertical load, that is to say a load that is perpendicular to the axis X and orientated essentially vertically. The wheel end A also transfers a moment derived from that vertical load, for after all the tire patch T is normally, but not required to be, offset from the center of the bearing 6. The vertical load tends to enlarge the air gap g. The moment produced by the vertical load, or the other hand, tends to close the air gap g. The static loads and the dimensions of the wheel end A should be such that the vertical load and the moment induced by it generally offset each other insofar as their effects on the size of gap g are concerned, and the gap remains essentially unchanged from the size it assumed at manufacture. This renders variations the gap g considerably more representative of lateral loads at the tire patch T than vertical loads. The sensor 10, of course, monitors the size of the gap g and produces a signal that reflects variations in size. Indeed, the configuration of the wheel end A should be such that variations in the gap g and in the signals produced by the sensor 10 are at least five times more sensitive to lateral loads than vertical loads. Basically, the wheel end A confines its sensor 10 to measurements in only one of several degrees of freedom, that being the lateral degree of freedom.

To be sure, the wheel end A may see radial loads other than vertical loads—for example, loads produced by brake calipers clamping down on the brake desk D. But the loads are generally offset about 90° from the vertical loads, so deflections caused by them are generally orthogonal to the sensor 10 and not detected by the sensor 10.

Thus, when a vehicle V provided wheel ends A travels over pavement in a straight course, the sensors 10 of the wheel ends A should not reflect any significant variations on their air gaps g. Should one of the road wheels C encounter a bump, the vertical load transmitted through it will increase and so will the overturning moment induced by that vertical load. The two to a good measure cancel each other.

However, should the vehicle V negotiate a turn (FIG. 3), the tires at their tire patches T will resist the inertial forces acting on the vehicle V. In other words, the inertia will create lateral forces F at the tire patches T. If the wheel end A is on the outside of the turn, the wheel end A will experience an inwardly directed (inboard) thrust or lateral load which is representative of the force F at the tire patch T, and which increases the size of the gap g. So does the moment produced by the force F. The sensor 10 detects the increase in the size of the gap g, and its signal reflects the new size. On the other hand, the wheel end A at the inside of the turn will experience an outwardly directed (outboard) thrust that seeks to pull the hub 4 out of the housing 2. The thrust force F at the tire patch T transfers through the wheel end A as a thrust or lateral load that decreases the size of the air gap g. The moment produced by the force F also reduces the size of the air gap g. The sensor 10 detects the change in the air gap g and generates a signal reflecting its smaller size.

Basically, the wheel end A mechanically isolates and amplifies responses to lateral loads, such as those resulting from inertial forces developed during a turn, and attenuates responses from vertical loads. Thus, the signal generated by the sensor 10 of each wheel end A is highly responsive to changes in lateral loads imposed at the tire patch T for the wheel end A, but not very responsive to changes in vertical or other radially directed loads. This renders the wheel end A and the signals produced by its sensor 10 well suited for stability control systems. The sensor 10 also produces signals that reflect the angular velocity of the road wheel C, and the signals so produced are likewise well-suited for stability control systems.

Actually, when the vehicle V negotiates a turn, the center of the tire patch T for a wheel C will move laterally relative to the wheel end A for that wheel C owing to inertial forces developed in the turn and the flexibility of the tire. An adjustment to the lateral load measurement is made based on the lateral acceleration of the vehicle C, estimating the lateral load location shift and its effect on output of the sensor 10 which would otherwise cause an error in the lateral load measurement.

A typical automotive vehicle V (FIG. 3) will have four road wheels C, each coupled to a suspension upright B of the vehicle V through a separate wheel end A. It will also have a stability control system S including a processor and a memory. The leads 82 from the wheel ends A connect with the stability control system S, so that the signals produced by the sensors 10, reflecting both speeds and the sizes of the gaps g, are sent to the processor in the system S. The system S may also receive signals reflecting steering wheel position and hence steering angle, longitudinal and lateral accelerations from an accelerometer, and the height of the center of gravity. The vehicle V will generally remain under control when it travels a straight course over level pavement. However, should the vehicle V experience a change in direction or an inclination from level, lateral forces F will develop in the wheels C at their tire patches T. These forces F will cause deflections in the wheel ends A, and those deflections will manifest themselves as changes for the size of the gap g at each wheel end A. The sensors 10 associated with the wheels C detect changes in the gaps g and send signals to the stability control system S that reflect those changes. The size of the gap g in any wheel end A represents the magnitude and direction of any lateral force acting at the tire patch T for the road wheel C mounted on that wheel end A.

The control system S utilizes the signals that represent the lateral forces F at the tire patches T and velocity, to effect any one or more of the following to avert a loss of control of the vehicle V: (1) apply brakes, (2) adjust engine speed, (3) adjust a steering parameter, such as angle or assist, and (4) stiffen suspension.

The stability control system S also monitors tire rolling radii—and by extension the inflation of the tires for the road wheels C. To this end, the control system S compares the angular velocity of the four wheels C and establishes a nominal tire rolling radius. Any deviation from that radius may signify under inflation or over inflation of the tire on a road wheel C. Also, calculations by the control system S for ascertaining lateral forces at the tire patch T are based on the nominal tire radius. Any deviation from that radius will result in an error for the load calculated. To calculate the deviation, the control system relies on lateral accelerations, which are derived directly from an accelerometer or are calculated from speed, steering angle, mass, and center of gravity. The lateral acceleration and tire vertical stiffness (similar to a spring rate) may be used to calculate a dynamic tire radius, which when composed with the nominal tire radius, allows one to compensate for the error in the measured load caused by the deviation of the dynamic tire radius from the nominal tire radius.

After a wheel end A is assembled, a known moment is applied to it. The response of the sensor 10 is compared against a standard response and a calibration value is written to the sensor memory. The calibration between sensor output and lateral tire force is periodically adjusted by the vehicle control system S based substantially on the sensor response to measured lateral acceleration. Over time, the vehicle control system may compare lateral acceleration values to the measured loads and further adjust the sensor calibrations. This lateral acceleration value may be computed from the steering angle and the vehicle speed and may be used to occasionally recalibrate the sensor 10 output based on average responses.

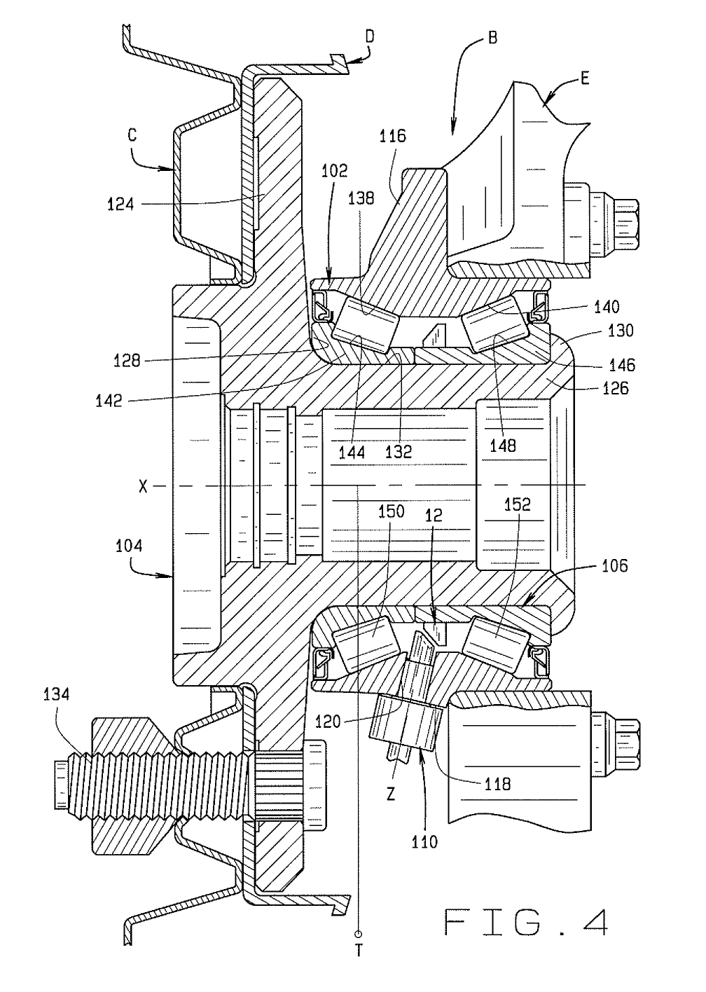

A modified wheel end B (FIG. 4) is shown which likewise couples a road wheel C to a suspension upright E on an automotive vehicle. It includes a housing 102, a hub 104, and a bearing 106 located between the housing 102 and the hub 104. In addition, the wheel end B has a sensor 110 fitted to the housing 102 and a target wheel 112 fitted to the bearing 106, the arrangement being such that the sensor 110 detects deflections within the wheel end B as well as the angular velocity of the hub 4 and the road wheel C attached to it. The housing 102 has a lobed flange 116 intermediate its ends. It fits against the suspension upright E to which it is firmly secured with cap screws 118 that pass through the suspension upright E and thread into the flange 116.

Between two of the lobes on the flange 116 the housing 102 has a land 118 that is flat and oblique to the axis X. Here the housing 102 is provided, preferably at or near the bottom dead center, with an oblique bore 120 having an axis Z that intersects the axis X, and preferably lies on a vertical or near vertical plane. The axis Z is generally at an angle of between 0 degrees and 30 degrees with respect to a vertical axis which is perpendicular to the X axis, and is preferably at an angle of 15 degrees with respect to the vertical axis. The land 118 is perpendicular to the axis Z of the bore 120. At its outer end the bore 120 opens downwardly out of the land 118. At its inner end it opens into the interior of the housing 102 generally midway between the ends of the housing 102. The sensor in FIG. 4 is shown generally with a sensing face 194 oblique to the axis Z. The sensor 110 may be a bottom-read sensor with its sensing face generally perpendicular to axis Z (between 90-45 degrees), or the sensor may be configured as a face-read sensor with its sensing face generally parallel to axis Z (between 45 and 0 degrees). Depending upon the sensor configuration, the target wheel axial location and the target wheel outer peripheral surface angle, with respect to axis x, are selected to dispose the outer peripheral surface of the target wheel parallel to the sensing face of the sensor, and to achieve the desired air gap g between the peripheral surface of the target wheel and the sensing face of the sensor. In FIG. 5, the target wheel is shown to the right of the sensor, but those of ordinary skill in the art will recognize that the target wheel may just as readily be disposed to the left of the sensor, and that the angles of the target wheel outer peripheral surface and the sensing face of the sensor may be modified to be parallel and obtain the desired air gap g.

The hub 104 includes a wheel flange 124 and a spindle 126 that projects from the wheel flange 124 into the housing 102. It emerges from the wheel flange 124 at a shoulder 128 and terminates at a formed end 130, there being a bearing seat 132 between the shoulder 128 and the formed end 130. The wheel flange 124 carries lug bolts 134 by which the road wheel C and brake disc D are secured to the hub 104.

The bearing 106 includes outboard and inboard outer raceways 138 and 140, respectively, that are tapered and form surfaces on the housing 102, although either one or both may also be on a separate race that is pressed into the housing 102. In any event, the raceways 138 and 140 taper downwardly toward each other and toward the inner end of the oblique bore 120. In addition, the bearing 106 has an outboard inner race 142 that fits over the bearing seat 132 of the spindle 126 with an interference fit and with its back face against the shoulder 128. It has a tapered raceway 144 that is presented outwardly toward the outboard outer raceway 138 and is inclined in the same direction. The outboard inner race 142 may be formed integral with the spindle 30. Also, the bearing 106 has an inboard inner race 146 that fits over the bearing seat 132 with an interference fit and with its back face against the formed end 130. The inboard inner race 146 has a tapered raceway 148 that is presented outwardly toward the inboard outer raceway 140 and is inclined in the same direction. Finally, the bearing 106 has rolling elements in the form of tapered rollers 150 organized in an outboard row between the outboard raceways 138 and 144 and more tapered rollers 152 organized in an inboard row between the inboard raceways 140 and 148.

The outboard rollers 150 are on apex, meaning that the envelopes containing the side faces of the rollers 150 have their apices at a common point along the axis X and likewise for the envelopes containing the outboard raceways 138 and 144. The same holds true for the inboard rollers 152 and raceways 140 and 148. Moreover, the bearing 106 is preferably set to slight preload so that no clearances exist between the rollers 150 and their raceways 138 and 144 and the rollers 152 and their raceways 140 and 148.

Other types of antifriction bearings may be substituted for the tapered roller bearing—for example, a ball bearing, a spherical roller bearing, or a cylindrical roller bearing.

The formed end 130 derives from a roll forming process undertaken only after the outboard inner race 142 and its rollers 150, the housing 102, and the inboard inner race 146 along with its rollers 152 and the target wheel 112 are installed around the spindle 126 of the hub 104, in that order. U.S. Pat. Nos. 6,443,622 and 6,532,666, which are incorporated herein by reference, disclose tools and processes for providing the formed end 130. Other arrangements for capturing the bearing 106 on the spindle 126 may be substituted for the formed end 130, such as a nut threaded over the end of the spindle 126 or a snap ring engaged with the spindle 126.

The sensor 110 fits into the oblique bore 120 of the housing 102 and lends itself to precise positioning with respect to the target wheel 112. The sensor may be bolted to the housing, and the axial location of the target wheel adjusted to obtain the desired air gap, as disclosed in U.S. Pat. No. 5,085,519. Alternatively, as shown in FIG. 5, the sensor 110 may include a bushing 160 that fits into the oblique bore 120 with a tight interference fit. At the inner end of the bore 120, the bushing 160 has a key 162 that is directed toward the bore axis Z. At its outer end the bushing 160 has a shoulder 164 that seats against the land 118 and beyond the shoulder 164 a lateral flange 166.

In addition to the bushing 160, the sensor 110 has an adjustment sleeve 170 that engages the bushing 160 and extends axially beyond it. In this regard, the sleeve 170 has at its one end an inwardly directed lip 172 that lies behind the lateral flange 166 of the bushing 160. Leading to its opposite end is an internal thread 174.

Within the bushing 160 and sleeve 170 is a sensor core 178 that is molded from a somewhat resilient polymer. It has a probe 180 that extends into the bushing 160 where it is provided with a keyway 182 into which the key 162 of the bushing 160 projects, thus preventing the core 178 from rotating in the bushing 160 and in the oblique bore 120. The core 178 also includes a head 184 that occupies the sleeve 170 where it is provided with an external thread 186 that engages the internal thread 174 of the sleeve 170. The head 184 also has a resilient biasing rib 188 that bears against the flange 166 on the bushing 160 and urges the entire core 178, and the sleeve 170 as well, outwardly away from the axis X. Only the lip 172 that engages the flange 166 of the bushing 160 prevents the biasing rib 188 from expelling the core 178 from the bushing 160. A coil spring fitted around the core 178 between the head 184 and the shoulder 164 of the bushing 160 or some other spring may be substituted for the biasing rib 188 to urge the core 178 outwardly.

The probe 180 carries an elastomeric O-ring 190 that establishes a fluid barrier between it and the bushing 160. The probe 180 projects beyond the inner end of the bushing 160 and into the interior of the housing 102. Here it has a sensing element 192 embedded within it. The element 192 has a sensing face 194 that is oblique to the axis Z of the bore 120 and to the axis X as well.

The target wheel 112 fits over the inboard inner race 146 beyond the small end of its raceway 148, although it may be fitted to the outboard inner race 142 as well and the outboard inner race may be integral with the hub 104. It The target wheel has a reference surface 196 that lies oblique to the axis X. Indeed, its angle to the axis X presents it parallel to the sensing face 194 on the probe 180 of the sensor 110 at the location where the target wheel 112 passes by the probe 180. The reference surface 196 lies within a conical envelope, the apex of which is along the axis X outboard from the sensor 110. The included angle between the reference surface 196 and the axis X should range between 0° and 90°, should preferably be in the 30° to 75° range, and most preferably be at about 45°.

The sensing element 192 has the capacity to measure and monitor the distance between its sensing face 194 and the reference surface 196 on the target wheel 112. It also has the capacity to measure and monitor the angular velocity of the target wheel 112 and hence the angular velocity of the hub 104 and wheel C. To this end, the target wheel 112 should have discontinuities of one type or another, for example, alternating magnetic poles, gear teeth, or stamped perforations.

The wheel end B is configured to attenuate and preferably cancel out vertical forces at the tire patch T so as to only transmit lateral forces acting parallel to the axis X. Thus, it provides a response for only one degree of freedom—the lateral one.

Again, the size of the gap g at assembly must be set with considerable precision. One achieves this by rotating the sleeve 170 of the sensor 110 (FIG. 5). Owing to the engaged threads of the sleeve 170 and core 178, the core 178, including its probe 180, moves within the oblique bore 120. The sensing element 192, which measures distance, provides a signal that indicates the size of the gap g, so one can obtain the proper spacing by monitoring the signal during rotation of the sleeve 170. Alternatively, the sensor may be fixed to the housing and the target wheel axial position adjusted to obtain the desired air gap.

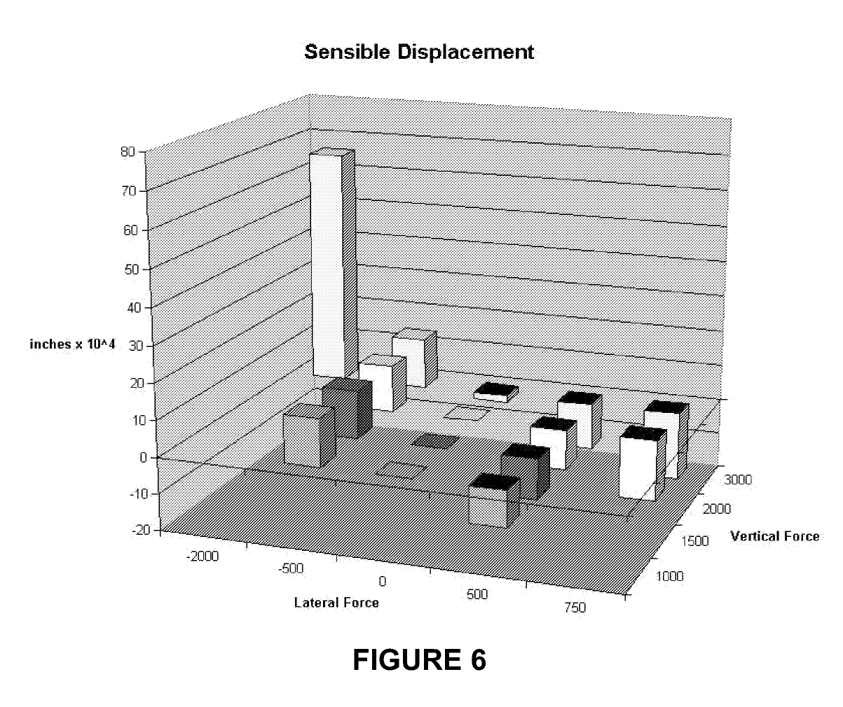

Referring to FIG. 6, deflections measurable at the sensor 10, 110 are plotted against various vertical and lateral tire loads to illustrate the function of the sensor. When no load is applied to the wheel end A, the deflection is taken as being zero. When the wheel end A is loaded with 1500 lbs of vertical force due to the weight of the vehicle, as in straight driving, the sensor 10, 110 detects no significant response due to the vertical loading owing to the favorable configuration of target wheel. However, when the vehicle corners, the wheel end A experiences lateral forces. As is apparent in the figure, there are substantial displacements observable at the sensor. Only when extremely high vertical forces are experienced, will there be some significant response by the sensor 10, 110 but substantially less than the response to lateral load. In fact the slight response to vertical load can be removed when high lateral accelerations are observed in the vehicle. The result is that the sensor is able to provide the vehicle control system with reliable information about the lateral tire loads to improve the response to desired vehicle path or eliminate undesired changes in vehicle path from force disturbances.

By comparing the signals derived from the sensors 10, 110 on the left and right wheel ends A for the front wheels C of a vehicle, one can obtain information useful for the operation of a vehicle stabilization system, particularly forces acting at the so-called tire patches where the road wheels C contact a road surface. The correlation between deflections and load may be established empirically. However, the wheel end A has utility other than that, because it monitors the magnitude of loads at the wheel ends A.

It will be recognized that lateral load information acquired by the sensors 10 and 110 may be utilized for a variety of different applications to alter vehicle operating parameters and vehicle suspension response parameters without departing from the scope of the invention. For example, one of the most critical functions in controlling vehicle stability is that the vehicle V points in a direction corresponding to the steering wheel angle. Adjustment of the steer angle of the front wheels C of the vehicle V is the primary means to control vehicle stability, but an enhanced method may use the individual vehicle wheel brakes to adjust this yaw angle. Tires have a maximum lateral force at a particular angle between their rotation direction and the road velocity, i.e. the side slip angle. With the lateral load sensing wheel ends A of the present invention, this side slip angle, determined by yaw angle, can be increased until the tire lateral load reaches a peak value, i.e. further yaw angle does not yield further increases in lateral load.

In another application, the relative traction, i.e., the right and left tire lateral loads, are compared during a turn of the vehicle V. If they show a significant difference, then a differential friction condition is evident between the vehicle wheels C and the road surface. When this condition is evident, the vehicle control system S is modified to respond differently. If the steering wheel is rotated, the control considers that the wheel C on one side will need to carry a greater share of the lateral load, perhaps resulting in loss of traction. The control system S may reduce power assist to the steering to increase steering effort in an attempt to minimize the steering input from the vehicle's drive, and to avoid a loss of traction. The braking force applies at the low friction wheel C will also be reduced by the control systems S to prevent loss of traction at that wheel. A low friction warning may be given to the driver to help avoid further dangerous operation.

Similarly, the sensors 10 and 110 may be utilized to identify wind gust parameters and/or road sideslope effects which require some sort of compensation to be applied to the vehicle V. As the vehicle V is driving and the lateral load sensing wheel ends A identify a sudden change that is not resulting from a change in steering angle, perhaps due to side wind gusts or changes in road sideslope, the steering angle is compensated to keep a constant vehicle path. Similarly, as the vehicle V is towing a trailer and the lateral load sensing wheel ends A determine periodic lateral load variations not resulting from a change in steering angle, the vehicle control system S may be configured to apply the trailer or vehicle brakes to vary drive torque or to adjust steering, or any combination, in a way as to stabilize the trailer side sway.

The sensors 10 and 110, owing to their capacity to monitor lateral loading, enable the vehicle control system S to detect the progression of vehicle roll as the vehicle V attempts to corner at too high a speed for a turn radius. As each inside wheel C lifts from the road, those wheels C will lose lateral tire force. When the second inside wheel C loses lateral force, the critical point of rollover has occurred. The vehicle control system S may intervene with control of individual brakes, driving torque, or steering, such that the vehicle V regains stability. Indeed, the control system S would adjust steering angle and brakes to reduce slip angle, that is lessen the severity of the turn, and thus reduce forces that seek to cause rollover.

The sensors 10 and 110 and their respective target wheels 12 and 112 may be utilized in single row bearings as well as in multirow bearings. For example, they may be used with deep groove ball bearings or single row tapered roller bearings that have the capacity to accommodate thrust loads in both axial directions, such as the bearing of U.S. Pat. No. 5,735,612, which is incorporated herein by reference.

1. A wheel end having outboard and inboard ends comprising:
a housing;
a hub having a spindle that extends into the housing;
a bearing located between the housing and the hub to enable the hub to rotate relative to the housing about a lateral axis, the bearing being configured to transfer radial and vertical loads between the housing and hub and also lateral loads in both directions along the lateral axis;
a target carried by the hub for rotation with the hub; and
a sensor carried by the housing and presented toward the target such that a gap exists between the sensor and the target, the sensor having the capacity to monitor the size of the gap and detect changes in it;
the wheel end being configured such that the sensor is more sensitive to lateral axially directed loads than to radially directed and vertical loads.

2. A wheel end according to claim 1 wherein the sensor is at least five times more sensitive to lateral axial loads than to radial and vertical loads.

3. A wheel end according to claim 1 wherein radial and vertical loads transmitted through the wheel end produce moment-induced deflections; and
wherein the moment-induced deflections have offsetting effects on the air gap size, so that the sensor is more responsive to lateral loads in the axial direction than to radially directed and vertical loads.

4. A wheel end according to claim 1 wherein the target and sensor are located axially inboard of the bearing.

5. A wheel end according to claim 4 wherein the target has a reference surface toward which the sensor is presented; and the reference surface is oriented at an angle of between 10° and 35° with respect to the lateral axis about which the bearing rotates.

6. A wheel end according to claim 4 wherein said sensor is disposed within an oblique bore at the bottom dead center of said housing, said oblique bore orientated at an angle of between 0 degrees and 30 degrees with respect to a vertical axis perpendicular to said lateral axis

7. A wheel end according to claim 6 wherein said oblique bore is orientated at an angle of 15 degrees with respect to said vertical axis.

8. A wheel end according to claim 1 wherein the bearing has rolling elements organized in two rows; and the target is disposed between the two rows.

9. A wheel end according to claim 8 wherein the target has a reference surface located oblique to the lateral axis, and the sensor has a sensing element that is presented toward the reference surface and may be moved inwardly and outwardly with respect to the lateral axis to set an initial size of the air gap.

10. A wheel end according to claim 8 wherein the target has a reference surface toward which the sensor is presented; and wherein the reference surface is orientated at an angle of between 30° and 75° with respect to the lateral axis about which the bearing rotates.

11. A wheel end according to claim 1 wherein the target has a reference surface and the sensor lies along an axis that is oblique to the reference surface.

12. A wheel end according to claim 1 wherein the sensor is further configured to produce a signal representative of any one or more of angular velocity, rotational angle, and temperature of the hub.

13. The wheel end according to claim 12 wherein said target includes at least one discontinuity, and wherein said sensor is configured to observe passage of said discontinuity during rotation of said target.

14. A wheel end according to claim 1 wherein the sensor is a face-read sensor.

15. A wheel end according to claim 1 wherein the sensor is a bottom-read sensor.

16. In an automotive vehicle having a suspension upright and a road wheel that contacts an underlying road surface at a tire patch, a wheel end for coupling the road wheel to the suspension upright, said wheel end comprising:
a housing attached to the suspension upright;
a hub having a wheel flange located beyond the outboard end of the housing and a spindle that projects from the wheel flange into the housing, the road wheel being mounted on the wheel flange;
a bearing located between the housing and the hub spindle for enabling the hub and road wheel to rotate about an axis, the center of the bearing being laterally offset along the axis of rotation with respect to the tire patch, whereby a vertical load applied to the wheel end will translate into both a vertical force and a moment within the wheel end;
a target carried by the hub and having a reference surface;
a sensor carried by the housing and having a sensor face presented toward the reference surface of the target such that a gap exists between the reference surface and the sensing face, the sensor having the capacity to produce a signal that is responsive to the size of the gap;
the wheel end being configured such that the vertical force and the moment induced by that force have offsetting effects on the size of the gap, so that lateral axial loads transmitted through the wheel end have the greatest effect on the size of the gap and the signals produced by the sensor are primarily representative of the magnitude and direction of lateral axial loads at the tire patch.

17. A wheel end according to claim 16 wherein the reference surface of the target is oblique to the lateral axis of rotation, and is orientated such that it is inclined downwardly toward the wheel flange of the hub.

18. A wheel end according to claim 16 wherein the target and sensor are located inboard of the rolling elements of the bearing.

19. A wheel end according to claim 16 wherein the target is located between the rolling elements of the bearing.

20. A wheel end according to claim 16 wherein the sensor is further configured to produce a signal which is representative of any one of angular velocity of the target, rotational angle of target, or temperature.

21. A wheel end according to claim 16 wherein said sensor is disposed within an oblique bore at the bottom dead center of said housing, said oblique bore orientated at an angle of between 0 degrees and 30 degrees with respect to a vertical axis perpendicular to said lateral axis

22. A wheel end according to claim 16 wherein said oblique bore is orientated at an angle of 15 degrees with respect to said vertical axis.

23. The wheel end according to claim 16 wherein said target wheel includes at least one discontinuity, said sensor further configured to observe passage of said discontinuity past said sensing face during rotation of said target wheel.

24. A process for monitoring lateral loads transmitted from a road wheel tire patch where the road wheel contacts a road surface, to a suspension upright through a wheel end, said process comprising:
at least in part, offsetting displacements between selected components within the wheel end caused by radial and vertical loads against displacements within wheel end between said selected components caused by moments imposed by such vertical loads, whereby remaining displacements between said selected components within the wheel end result primarily from lateral loads in the axial direction; and
monitoring said remaining displacements within said wheel end.

25. The process of claim 24 and further including adjusting a sensor configuration responsive to said monitored displacements within said wheel end during assembly of said wheel end.

26. The process of claim 24 and further including identifying a loss of traction at said tire patch responsive to said monitored displacements within said wheel end.

27. The process of claim 24 and further including regulating a vehicle operating parameter responsive to said monitored displacements within said wheel end, said vehicle operating parameters selected from a set of vehicle operating parameters including, but not limited to, an applied braking force, a wheel steering parameter, vehicle drive torque, and vehicle suspension parameter.

28. The process of claim 24 wherein said the monitoring includes measuring said displacements along an axis which is not perpendicular to the axis of rotation.

29. The process of claim 24 further including calibrating a sensor by monitoring said remaining displacements within said wheel end resulting from the application of a known load to the wheel end components.

30. The process of claim 29 further including storing sensor calibration data in a memory associated with said sensor.

31. The process of claim 24 further including adjusting a calibration setting of a sensor by monitoring said remaining displacements within said wheel end responsive to lateral accelerations of said wheel end over time.

32. The process of claim 24 further including monitoring a road wheel tire rolling radii for a plurality of wheels on a vehicle, said monitoring including comparing an angular velocity for a plurality of wheels to establish a nominal tire rolling radius.

33. The process of claim 24 further including compensation for errors in said remaining displacement at a wheel end caused by deviations of the actual dynamic tire rolling radius from a nominal tire rolling radius, with the compensating, including ascertaining the dynamic tire rolling radius from lateral accelerations and tire stiffness.

34. The process of claim 24 further including detecting and counteracting wind gust or sideslope effect or both by monitoring said remaining displacements within the wheel end and adjusting vehicle operating parameters selected from a group, including braking, steering angle, drive torque, and suspension stiffness.

35. The process according to claim 24 wherein the automotive vehicle tows a trailer having brakes, and further including adjusting any one or more of the brakes in the trailer, the brakes or the vehicle, engine power, and steering to counteract undesired movements of the trailer by monitoring said remaining displacements within the wheel end.

36. The process according to claim 24 further comprising controlling the yaw of the vehicle by monitoring said remaining displacements in the wheel end.

37. The process according to claim 24 further comprising compensating for lateral shift in the wheel end relative to the tire patch, owing to the flexibility of the tire and the presence of inertial forces in a turn, by monitoring lateral acceleration and estimating the shift attributable to such lateral acceleration.

38. The process according to claim 24 further comprising using the remaining displacements to detect loss of contact of a wheel with a road surface in a turn and to detect the onset of rollover from the loss of contact of multiple wheels on one side of the vehicle and controlling brakes, drive torque or steering, or any combination to avert rollover.

39. The process of claim 24 and further comprising using the remaining displacements in the wheel end to determine when the side slip angle has reached the point at which maximum lateral force is obtained.
